(19) United States
(12) Patent Application Publication
(10) Pub. No.: US 2006/0177123 A1
(43) Pub. Date: Aug. 10, 2006

(54) Method and apparatus for encoding and decoding stereo image

(75) Inventor: Tae-hyeun Ha, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/273,413

(22) Filed: Nov. 15, 2005

(30) Foreign Application Priority Data
Feb. 4, 2005 (KR) 10-2005-0010754

(51) Int. Cl. G01C 3/14; H04N 13/00; G06K 9/00; G06T 15/00

(52) U.S. Cl. 382/154; 348/42; 345/419; 356/12

(57) ABSTRACT

A method and apparatus are provided for encoding and decoding a stereo image through motion estimation performed in a block using a search area that is temporally or spatially separated from the block according to the position of the block. The method of encoding a stereo image includes determining the position of a block to be motion-estimated, selectively performing time domain motion estimation or spatial domain motion estimation according to the determined position, and performing motion compensation according to the result of motion estimation.

### CROSS-REFERENCE TO RELATED PATENT APPLICATION

This application claims priority from Korean Patent Application No. 10-2005-0010754, filed on Feb. 4, 2005, in the Korean Intellectual Property Office, the disclosure of which is incorporated herein in its entirety by reference.

### BACKGROUND OF THE INVENTION

1. Field of the Invention

Methods and apparatuses consistent with the present invention relate to encoding and decoding of a stereo image, and more particularly, to encoding and decoding a stereo image through motion estimation performed in a block using a search area that is temporally or spatially separated from the block according to the position of the block.

2. Description of the Related Art

Recently, research has been conducted on broadcasting three-dimensional (3D) images through digital televisions (DTVs). To broadcast 3D images that are similar to actual images viewed by naked human eyes, multi-view 3D images should be created, transmitted, received, and reproduced by a 3D display device. However, since multi-view 3D images contain a large amount of data, they cannot be accommodated by a channel bandwidth used in an existing digital broadcasting system. Thus, priority is being given to studies on the transmission and reception of stereo images.

With respect to 3D image-related technology, the Moving Picture Expert Group (MPEG) developed the MPEG-2 multi-view profile in 1996 and a standard for compression of stereo images and multi-view images is on its way to completion. Related organizations studying 3D images are also actively conducting research on the transmission and reception of 3D images through DTV broadcasting and are currently looking into the transmission and reception of high definition (HD) stereo images. HD stereo images indicate interlaced images with resolutions of 1920×1080 or progressive images with resolutions of 1024×720.

However, since the bandwidth of a transmission channel that transmits MPEG-2 encoded images is limited to 6 MHz in DTV broadcasting, only one HD image can be transmitted through one channel. As a result, it is difficult to transmit an HD stereo image (composed of a left view image and a right view image).

To overcome such a problem, in conventional techniques, an HD stereo image is transmitted after reducing the amount of data of the HD stereo image to that of an HD mono image by sampling the HD stereo image, i.e., a left view image and a right view image, at a ratio of 1:2 to reduce the amount of data of the HD stereo image by ½ or after reducing the amount of data of the HD stereo image by reducing the size of one of the left view image and the right view image. However, since such conventional techniques reduce the amount of data through sub-sampling or size reduction, image quality degradation is inevitable.

Moreover, although a stereo image with a reduced amount of data is created in the above-described manner, a compression rate varies according to a method of motion estimation and compensation used when encoding the stereo image. In conventional encoding methods, a left view image and a right view image that constitute a stereo image are separately processed and motion of a macroblock of the left or right view image in a current frame is estimated using a specific area of the same view image of a previous frame as a search area in the time domain.

Alternatively, motion of a macroblock in a current frame may be estimated using not only a previous frame but also another view image constituting a stereo image as search areas. For example, when motion of a macroblock of a left view image in a current frame is estimated, not only a left view image in a previous frame but also a right view image in the current frame can be used as search areas.

However, such conventional methods are inefficient because they do not use similarities between a left view image and a right view image. Furthermore, since temporal and spatial motion estimation should be performed every time, a large amount of time is required for encoding.

### SUMMARY OF THE INVENTION

The present invention provides a method and apparatus for encoding and decoding a stereo image through motion estimation performed in a block using a search area that is temporally or spatially separated from the block according to the position of the block.

According to an aspect of the present invention, there is provided a method of encoding a stereo image. The method comprises determining the position of a block to be motion-estimated, selectively performing time domain motion estimation or spatial domain motion estimation according to the determined position, and performing motion compensation according to the result of motion estimation.

The spatial domain motion estimation is performed when the determined position is located on the left side of a left view image of the stereo image or the right side of a right view image of the stereo image.

The time domain motion estimation may be performed using a frame prior to a frame including the block to be motion-estimated and spatial domain motion estimation may be performed using another view image of the frame including the block to be motion-estimated.

The stereo image may be in a side-by-side format or a top-down format.

According to another aspect of the present invention, there is provided an apparatus for encoding a stereo image. The apparatus comprises a frame memory receiving and storing the stereo image, a motion estimation unit determining the position of a block to be motion-estimated and selectively performing time domain motion estimation or spatial domain motion estimation according to the determined position, and a motion compensation unit performing motion compensation according to the result of motion estimation.

The motion estimation unit may comprise a search area determination unit determining the position of the block to be motion-estimated, a time domain motion estimation unit performing time domain motion estimation to output a motion vector according to the result of determination, and a spatial domain motion estimation unit performing spatial domain motion estimation to output a disparity vector according to the result of determination.

According to still another aspect of the present invention, there is provided a method of decoding a stereo image. The method comprises receiving an encoded bitstream and extracting a stereo image and motion estimation information from the received bitstream and selectively performing motion compensation through time domain motion estimation or spatial domain motion estimation based on the motion estimation information.

According to yet another aspect of the present invention, there is provided an apparatus for decoding a stereo image. The apparatus comprises a decoding unit receiving an encoded bitstream and extracting a stereo image and motion estimation information from the received bitstream and a motion compensation unit selectively performing motion compensation through time domain motion estimation or spatial domain motion estimation based on the motion estimation information.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating the general creation of a stereo image by synthesizing a left view image and a right view image that are captured by a stereo camera;

FIGS. 2A through 2D illustrate various formats of a stereo image;

FIG. 3 is a block diagram of a general apparatus for transmitting a stereo image;

FIG. 4 is a block diagram of a general apparatus for receiving a stereo image;

FIG. 5 illustrates an example of a stereo image in the side-by-side format over time;

FIGS. 6A and 6B illustrate search areas for motion estimation for a stereo image in the side-by-side format;

FIGS. 7A and 7B illustrate search areas for motion estimation for a stereo image in the top-down format;

FIG. 8 is a block diagram of an apparatus for encoding a stereo image according to an exemplary embodiment of the present invention;

FIG. 9 is a view for explaining motion estimation in the time domain;

FIG. 10 is a block diagram of an apparatus for decoding a stereo image according to an exemplary embodiment of the present invention;

FIG. 11 is a flowchart illustrating a method of encoding a stereo image according to an exemplary embodiment of the present invention; and

FIG. 12 is a flowchart illustrating a method of decoding a stereo image according to an exemplary embodiment of the present invention.

### DETAILED DESCRIPTION OF EXEMPLARY EMBODIMENTS OF THE INVENTION

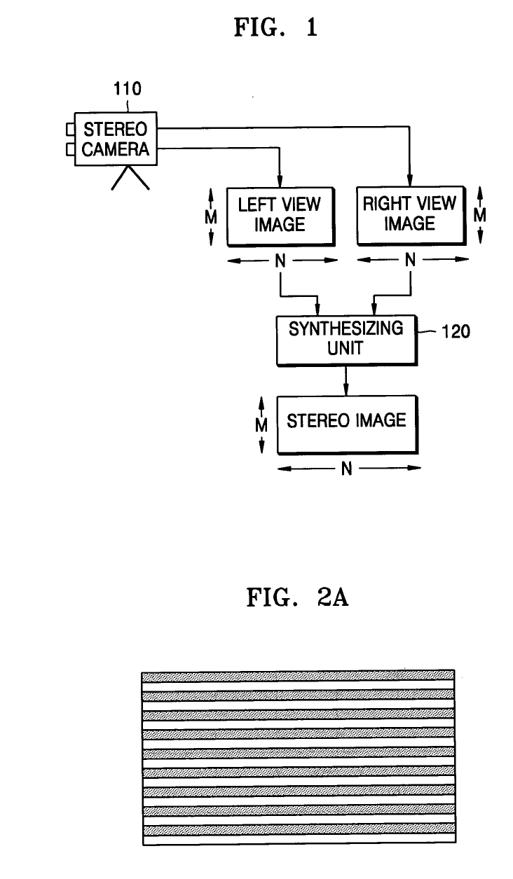

FIG. 1 is a block diagram illustrating the general creation of a stereo image by synthesizing a left view image and a right view image captured by a stereo camera.

Referring to FIG. 1, a stereo camera 110 separately captures a left view image and a right view image of an object. When the left view image and the right view image are HD images, the amounts of data of the left view image and the right view image are separately reduced to ½ by sub-sampling the left view image and the right view image for transmission through a channel having a bandwidth of 6 MHz. In other words, a synthesizing unit 120 sub-samples and then synthesizes the left view image and the right view image to create an HD stereo image.

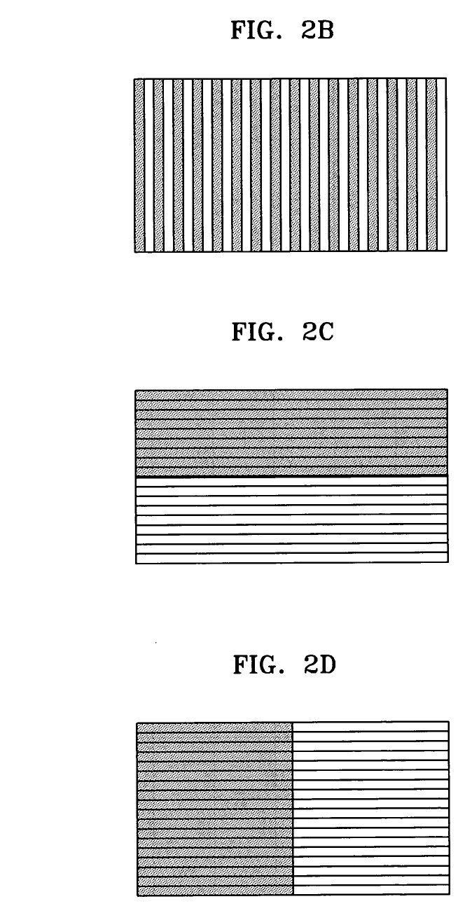

When the synthesizing unit 120 sub-samples and synthesizes the left view image and the right view image, it can synthesize the two images into various formats. Sub-sampling varies according to a format of a stereo image to be created. Hereinafter, the creation of a stereo image by the synthesizing unit 120 will be described with reference to FIGS. 2A through 2D.

FIGS. 2A through 2D illustrate various formats of a stereo image.

FIG. 2A illustrates a line-by-line format of a stereo image. To create a stereo image using the line-by-line format, a left view image and a right view image are separately ½ sub-sampled in the vertical direction and each line of pixels of the sampled left view image and each line of pixels of the sampled right view image are alternated with each other. FIG. 2B illustrates a pixel-by-pixel format of a stereo image. To create a stereo image using the pixel-by-pixel format, a left view image and a right view image are separately ½ sub-sampled in the horizontal direction and pixels of the sampled left view image and pixels of the sampled right view image are alternated with each other. FIG. 2C illustrates a top-bottom format of a stereo image. To create a stereo image using the top-bottom format, a left view image and a right view image are separately ½ sub-sampled in the vertical direction, the sampled left view image is positioned in a top half of the stereo image, and the sampled right view image is positioned in a bottom half of the stereo image. In other words, an N×M left view image and an N×M right view image are separately sub-sampled into N×M/2 images, the sampled N×M/2 left view image is positioned in a top half of the stereo image, and the sampled N×M/2 right view image is positioned in a bottom half of the stereo image, thereby creating an N×M stereo image. FIG. 2D illustrates a side-by-side format of a stereo image. In this case, a left view image and a right view image are separately ½ sub-sampled in the horizontal direction, the sampled left view image is positioned in a left half of a stereo image, and the sampled right view image is positioned in a right half of the stereo image. In other words, an N×M left view image and an N×M right view image are separately ½ sub-sampled into N/2×M images, the N/2×M sampled left view image is positioned in a left half of the stereo image, and the N/2×M sampled right view image is positioned in a right half of the stereo image, thereby creating an N×M stereo image.

Among the various formats of a stereo image, the top-bottom format shown in FIG. 2C and the side-by-side format shown in FIG. 2D are efficient for MPEG compressed image transmission, and thus have been widely used.

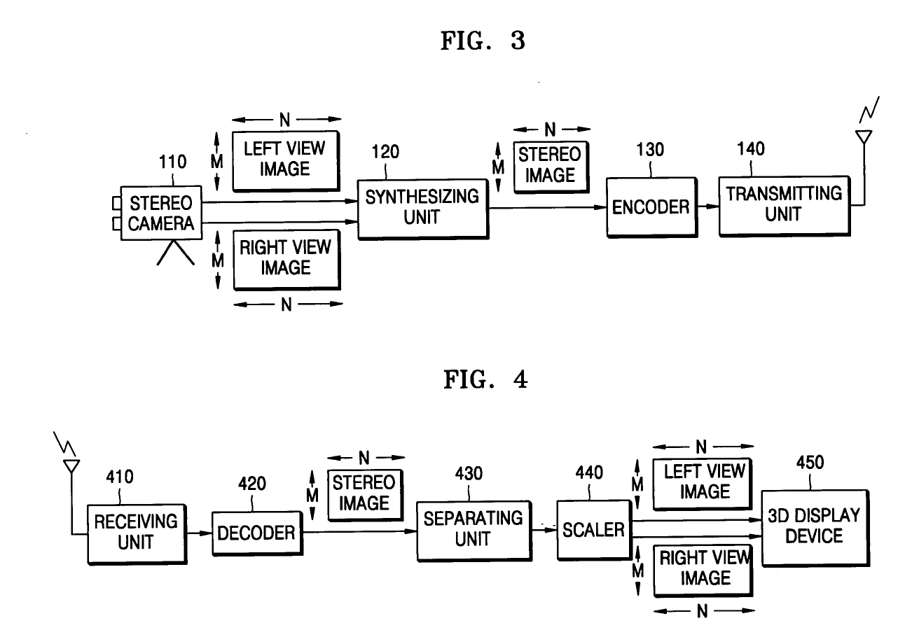

FIG. 3 is a block diagram of a general apparatus for transmitting a stereo image.

Referring to FIG. 3, an N×M left view image and an N×M right view image that are captured by the stereo camera 110 are sub-sampled and synthesized by the synthesizing unit 120 into an N×M stereo image having one of the various formats described with reference to FIGS. 2A through 2D. An encoder 130 encodes the created stereo image according to MPEG or various standards. A transmitting unit 140 transmits the encoded stereo image according to a digital broadcasting standard or other transmission standards.

FIG. 4 is a block diagram of a general apparatus for receiving a stereo image.

Referring to FIG. 4, a receiving unit 410 receives the stereo image transmitted from the apparatus for transmitting a stereo image. A decoder 420 performs decoding according to the encoding standard used by the apparatus for transmitting a stereo image. For example, if encoding is performed in accordance with the MPEG-2 standard, decoding is also performed according to the MPEG-2 standard. The N×M stereo image output from the decoder 420 is input to a separating unit 430 to separate the stereo image into a left view image and a right view image. Since sub-sampling is performed during the creation of a stereo image to reduce the amounts of data of the left view image and the right view image, the sizes of the separated left view image and right view image are smaller than their original sizes. Thus, a scaler 440 scales the separated left view image and right view image to their original sizes. If the received stereo image has the top-bottom format, the scaler 440 up-scales the separated left view image and right view image in the vertical direction. If the received stereo image has the side-by-side format, the scaler 440 up-scales the separated left view image and right view image in the horizontal direction. In other words, an N×M left view image and an N×M right view image are obtained. A 3D display device 450 displays the created left view image and right view image.

In the apparatus for transmitting or receiving a stereo image, the resolutions of the left view image and the right view image are reduced by ½ to transmit the stereo image through a limited-bandwidth channel. As a result, the resolution of the received stereo image is also reduced by ½. In other words, since the synthesizing unit 120 down-samples a left view image and a right view image during the creation of the stereo image, loss of image quality cannot be overcome even if the scaler 440 scales the down-sampled left view image and right view image to their original sizes.

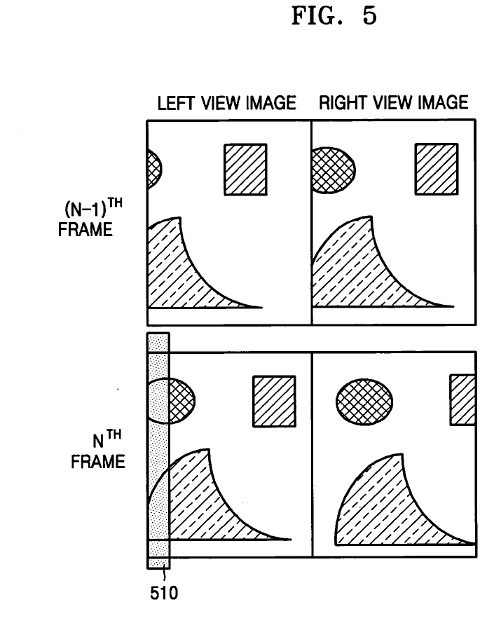

FIG. 5 illustrates an example of a stereo image in the side-by-side format over time.

As shown in FIG. 5, to create and then transmit a stereo image in the side-by-side format, a left view image and a right view image are synthesized in the horizontal direction. Such synthesis is repeated for each frame. When the stereo image created in the above manner is motion-estimated and encoded in a time domain, a left-side area 510 of an n^{th} frame cannot be determined from an (n−1)^{th} frame. In other words, even when searching is performed using a predetermined area of the (n−1)^{th} frame as a search area, a block that is similar to a block of the left-side area 510 cannot be found.

Since the background of the left view image is inclined to the right and the background of the right view image inclines to the left due to the characteristic of a stereo image, a block that is similar to a block of the left-side area 510 having no redundancy in the time domain can be found by searching in the right view image.

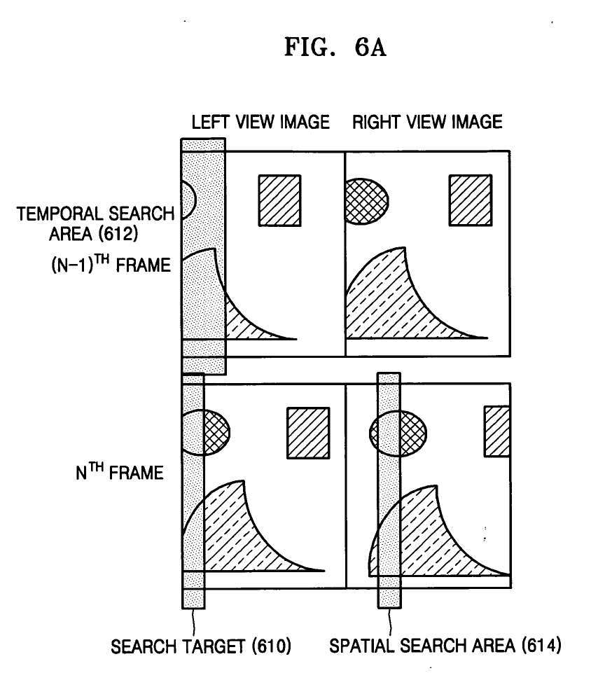

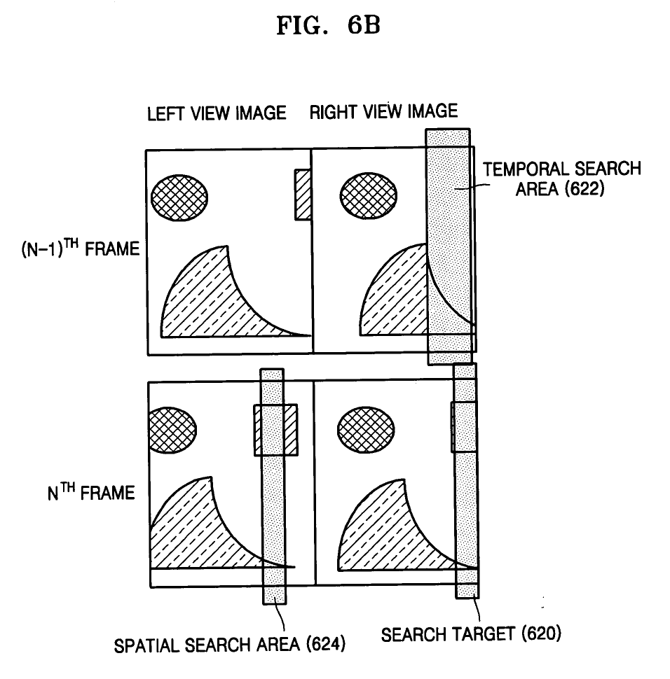

FIGS. 6A and 6B illustrate search areas for motion estimation for a stereo image in the side-by-side format.

Referring to FIG. 6A, a block that is similar to a search target 610 of an n^{th} frame cannot be found from a temporal search area 612 of an (n−1)^{th} frame. However, the similar block can be found from a spatial search area 614 of a right view image of the n^{th} frame. Similarly, referring to FIG. 6B, a block that is similar to a search target 620 of an n^{th} frame cannot be found from a temporal search area 622 of the (n−1)^{th} frame, but can be found from a spatial search area 624 of a left view image of the n^{th} frame.

In other words, an image that is similar to left-most blocks of a left view image of a stereo image of a frame can be found from a predetermined area of a right view image of the same frame and an image that is similar to right-most blocks of a right view image of a frame can be found from a predetermined area of a left view image of the same frame.

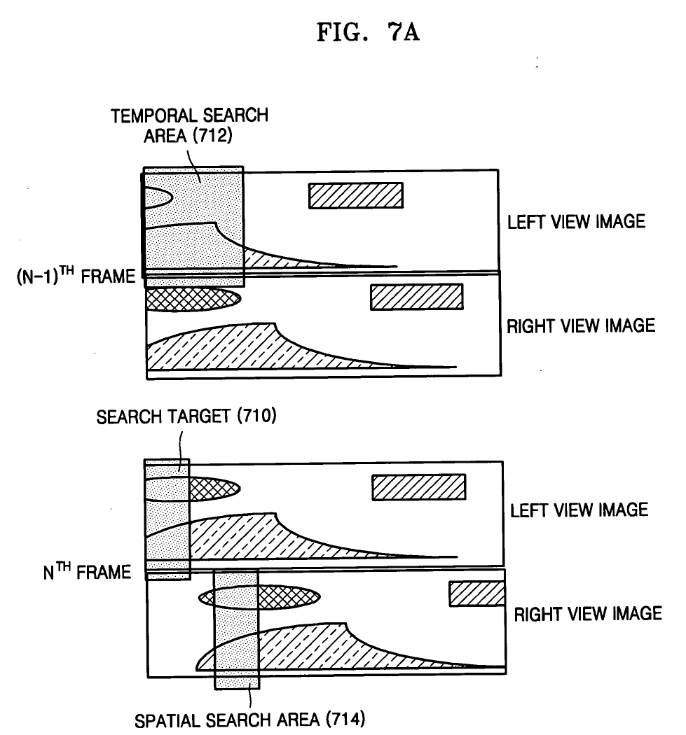

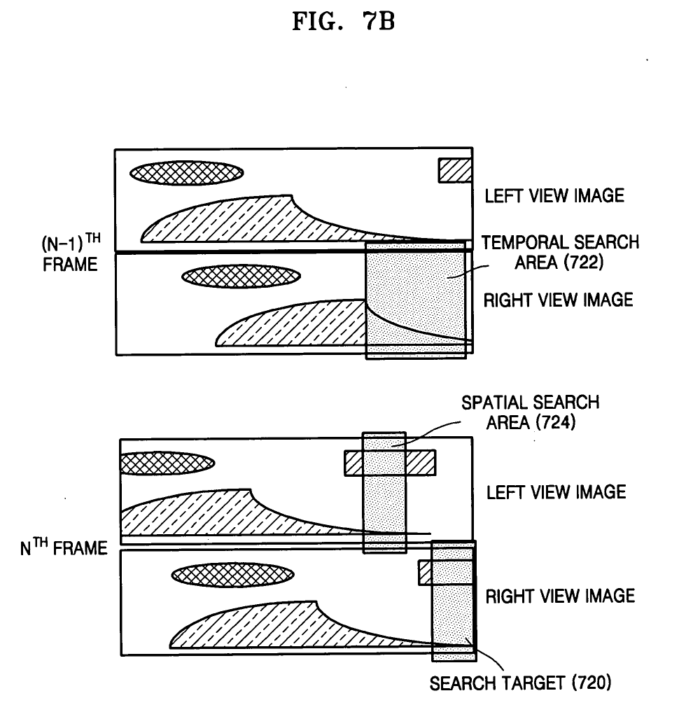

FIGS. 7A and 7B illustrate search areas for motion estimation for a stereo image in the top-down format.

Referring to FIGS. 7A and 7B, it can be seen that the stereo image in the top-down format can be also processed in the same manner as the stereo image in the side-by-side format.

In other words, a block that is similar to a search target 710 of an n^{th} frame cannot be found from a temporal search area 712 of an (n−1)^{th} frame, but can be found from a spatial search area 714 of a right view image of the n^{th} frame. Similarly, referring to FIG. 7B, a block that is similar to a search target 720 of an n^{th} frame cannot be found from a temporal search area 722 of the (n−1)^{th} frame, but can be found from a spatial search area 724 of a left view image of the n^{th} frame.

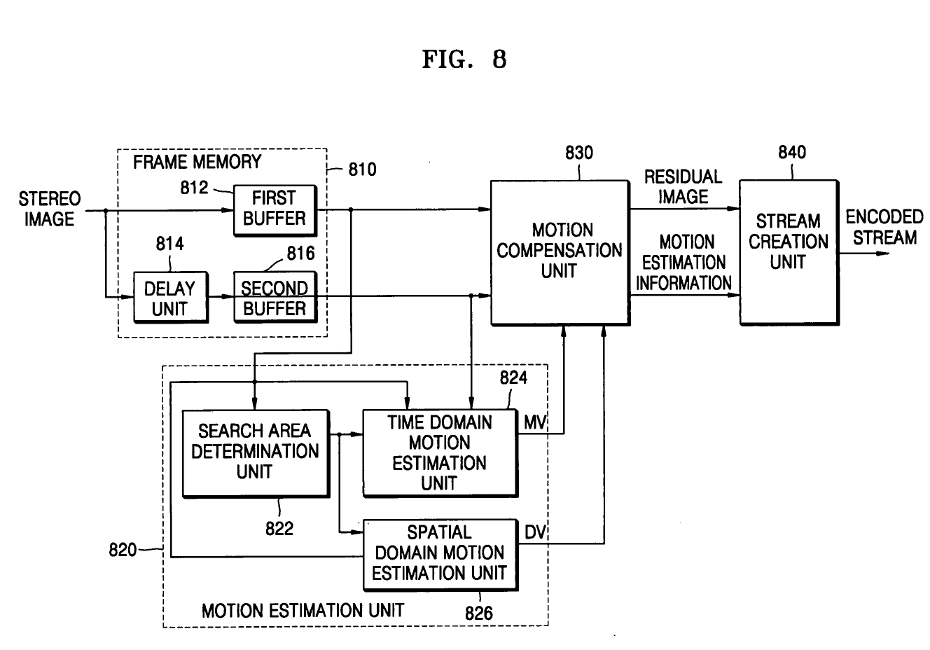

FIG. 8 is a block diagram of an apparatus for encoding a stereo image according to an exemplary embodiment of the present invention.

The apparatus for encoding a stereo image includes a frame memory 810, a motion estimation unit 820, a motion compensation unit 830, and a stream creation unit 840. The frame memory 810 includes a first buffer 812, a delay unit 814, and a second buffer 816. The motion estimation unit 820 includes a search area determination unit 822, a time domain motion estimation unit 824, and a spatial domain motion estimation unit 826.

The frame memory 810 receives and stores a stereo image that is composed of a left view image and a right view image. For motion estimation of an n^{th} frame, an (n−1)^{th} frame is also stored in the frame memory 810. To this end, the n^{th} frame is stored in the first buffer 812 and the (n−1)^{th} frame is stored in the second buffer 816 after passing through the delay unit 814.

The motion estimation unit 820 searches for a macroblock that is similar to a macroblock of the n^{th} frame from a search area of the (n−1)^{th} frame or from a search area of another view image in the n^{th} frame. Motion estimation may be performed in units of macroblocks or blocks of a predetermined size. The search area determination unit 822 checks the position of a macroblock in a current frame whose motion is being estimated to determine whether to perform time domain motion estimation or spatial domain motion estimation. In other words, as described with reference to FIGS. 6A and 6B, the search area determination unit 822 determines whether a search target is located on the left-most side of a left view image or on the right-most side of a right view image, controls the spatial domain motion estimation unit 826 to perform spatial domain motion estimation if the search target is located on the left-most side of the left view image or on the right-most side of the right view image, and controls the time domain motion estimation unit 824 to perform time domain motion estimation otherwise.

The time domain motion estimation unit 824 estimates motion of a macroblock of a current frame (the n^{th} frame) using a previous frame (the (n−1)^{th} frame) as a search area. The spatial domain motion estimation unit 826 estimates motion of a macroblock of the current frame (the n^{th} frame) using another view image of the current frame (the n^{th} frame) as a search area. The time domain motion estimation unit 824 outputs a motion vector (MV). The spatial domain motion estimation unit 826 outputs a disparity vector (DV).

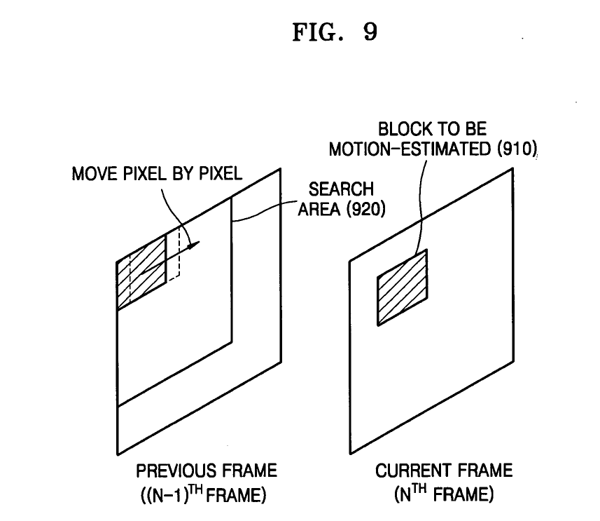

FIG. 9 is a view for explaining time domain motion estimation.

Searching performed for time domain motion estimation will now be described in detail. Time domain motion estimation is the process of obtaining an MV indicating a difference between moved positions of macroblocks by searching in a previous frame for a macroblock that is most similar to a macroblock of a current frame using a predetermined measuring function. There are various methods of searching for the most similar macroblock. As an example, the most similar macroblock may be searched for by moving a macroblock pixel by pixel within a search range and calculating the similarity between macroblocks.

Referring to FIG. 9, to estimate motion of a block 910 of a predetermined size in a current frame, e.g., a macroblock, by referring to a previous frame, a predetermined search area 920 is determined from the previous frame, a block of the same size as the block 910 is moved pixel by pixel within the predetermined search area 920 in the previous frame, and a pixel value of the block 910 and a pixel value of a block of the predetermined search area 920 are compared to search for the most similar block. To determine whether a corresponding block is the most similar block, for example, a block having a minimum sum of absolute differences (SAD) may be determined to be the most similar block and pixels corresponding to the block may be determined to be integer pixels obtained through integer pixel motion estimation.

To measure similarity, for example, absolute differences between pixel values of macroblocks in a current frame and a search area are calculated and a macroblock having a minimum sum of absolute differences may be determined to be the most similar macroblock.

More specifically, similarity between macroblocks in a previous frame and a current frame is determined using a similarity value, i.e., a matching reference value, calculated using pixel values of the macroblocks in the previous frame and the current frame. The similarity value, i.e., the matching reference value, is calculated using a predetermined measuring function such as an SAD, a sum of absolute transformed differences (SATD), or a sum of squared differences (SSD).

The motion compensation unit 830 creates and outputs a residual image, which is a difference between pixel values according to an MV or a DV, and the stream creation unit 840 creates the residual image into an encoded stream using MPEG-2 or another stream creation methods. When the encoded stream is created, motion estimation information indicating whether time domain motion estimation or spatial domain motion estimation was performed is also included in the encoded stream.

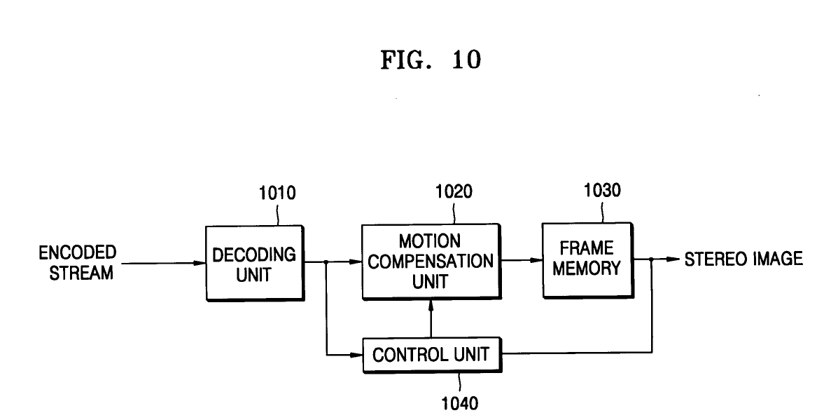

FIG. 10 is a block diagram of an apparatus for decoding a stereo image according to an exemplary embodiment of the present invention.

The apparatus for decoding a stereo image includes a decoding unit 1010, a motion compensation unit 1020, a frame memory 1030, and a control unit 1040. The decoding unit 1010 receives and decodes an encoded stream. A stereo image is created through decoding. The decoding unit 1010 also outputs motion estimation information indicating whether the stereo image is created through time domain motion estimation or spatial domain motion estimation.

The motion compensation unit 1020 performs time domain motion estimation or spatial domain motion estimation according to the motion estimation information. More specifically, when the motion estimation information indicates time domain motion estimation, the motion compensation unit 1020 receives previous frame data stored in the frame memory 1030 by the control unit(1040) and performs motion compensation. When the motion estimation information indicates spatial domain motion estimation, the motion compensation unit 1020 performs motion compensation using other view data in the same frame to reconstruct the original image. The frame memory 1030 stores the reconstructed image for use in motion estimation and outputs the reconstructed image.

The control unit 1040 receives a previous frame stored in the frame memory 1030, transmits the same to the motion compensation unit 1020, receives the motion estimation information from the decoding unit 1010, and controls the motion compensation unit 1020 to perform motion compensation through time domain motion estimation or spatial domain motion estimation.

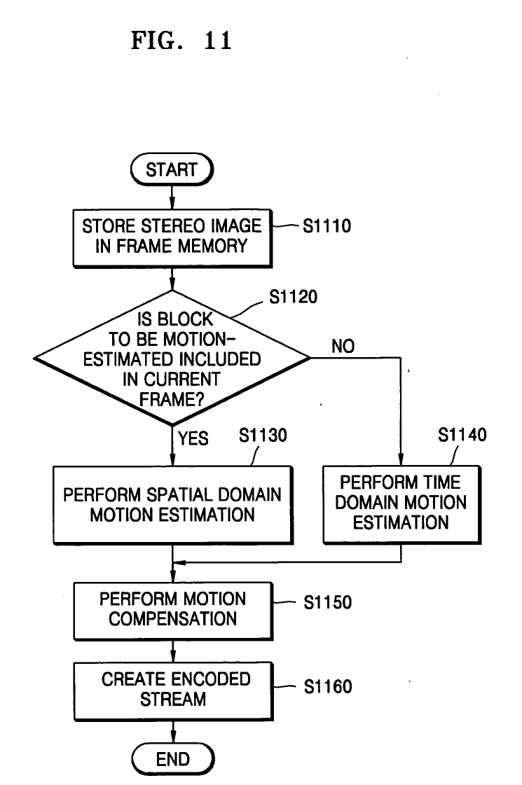

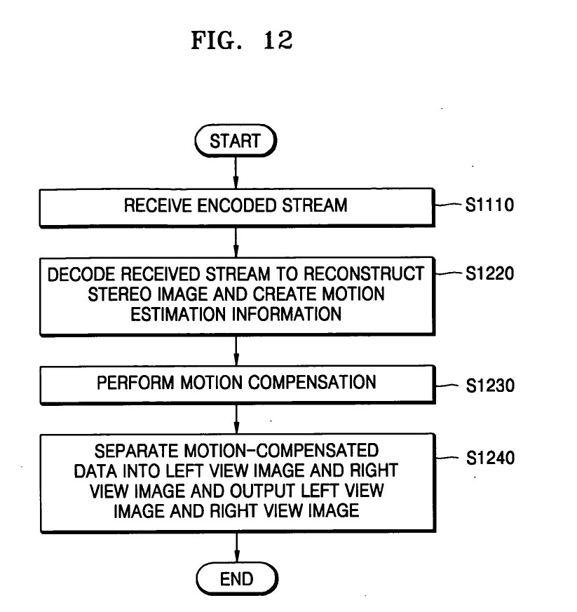

FIG. 11 is a flowchart illustrating a method of encoding a stereo image according to an exemplary embodiment of the present invention.

In operation S1110, a stereo image is received and stored in a frame memory. At this time, data of a current frame as well as data of a previous frame are stored. A search area determination unit 822 determines where a block to be motion estimated is located in operation S1120. If the block to be motion estimated is located on the right-most side of a right view image or on the left-most side of a left view image and thus motion estimation cannot be performed using a previous frame, spatial domain motion estimation is performed in operation S1130. Otherwise, time domain motion estimation is performed in operation S1140 in which a similar block is searched for in a previous frame. Once an MV or a DV is obtained through motion estimation, motion compensation is performed using the obtained MV or DV in operation S1150. Motion compensation is performed as described above with reference to FIG. 8. In operation S1160, a motion-compensated residual image is encoded into an encoded stream using a predetermined method. At this time, motion estimation information indicating whether time domain motion estimation or spatial domain motion estimation is performed is also included in the encoded stream.

FIG. 12 is a flowchart illustrating a method of decoding a stereo image according to an exemplary embodiment of the present invention.

In operation S1210, an encoded stream is received. In operation S1220, the encoded stream is decoded to reconstruct a stereo image and motion estimation information is created. Motion compensation is performed according to the created motion estimation information in operation S1230. Motion-compensated data is separated into a left view image and a right view image which are output to a three-dimensional display device in operation S1240.

As described above, according to the present invention, motion estimation is performed on a block using a search area that is temporally or spatially separated from the block according to the position of the block, thereby improving compression efficiency.

The method of encoding and decoding a stereo image can also be embodied as a computer program. Code and code segments forming the computer program can be easily construed by computer programmers skilled in the art. Also, the computer program can be stored in computer readable media and read and executed by a computer, thereby implementing the method of encoding and decoding of a stereo image. Examples of the computer readable media include magnetic tapes, optical data storage devices, and carrier waves.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of encoding a stereo image, the method comprising:
determining a position of a block to be motion-estimated;
selectively performing time domain motion estimation or spatial domain motion estimation according to the position; and
performing motion compensation according to a result of the performing the time domain motion estimation or the spatial domain motion estimation.

2. The method of claim 1, wherein the spatial domain motion estimation is performed if the position is located on a left side of a left view image of the stereo image or a right side of a right view image of the stereo image.

3. The method of claim 1, wherein the time domain motion estimation is performed using a frame prior to a frame including the block to be motion-estimated and the spatial domain motion estimation is performed using another view image of the frame including the block to be motion-estimated.

4. The method of claim 1, wherein the stereo image is in a side-by-side format or a top-down format.

5. An apparatus for encoding a stereo image, the apparatus comprising:
a frame memory which receives and stores the stereo image;
a motion estimation unit which determines a position of a block to be motion-estimated and selectively performs time domain motion estimation or spatial domain motion estimation according to the position; and
a motion compensation unit which performs motion compensation according to a result of the time domain motion estimation or the spatial domain motion estimation performed by the motion estimation unit.

6. The apparatus of claim 5, wherein the motion estimation unit performs the spatial domain motion estimation if the determined position is located on a left side of a left view image of the stereo image or a right side of a right view image of the stereo image.

7. The apparatus of claim 5, wherein the motion estimation unit comprises:
a search area determination unit which determines the position of the block to be motion-estimated;
a time domain motion estimation unit which performs the time domain motion estimation to output a motion vector according to the position determined by the search are determination unit; and
a spatial domain motion estimation unit which performs the spatial domain motion estimation to output a disparity vector according to the position determined by the search area determination unit.

8. The apparatus of claim 5, wherein the time domain motion estimation is performed using a frame prior to a frame including the block to be motion-estimated and the spatial domain motion estimation is performed using another view image in the frame including the block to be motion-estimated.

9. The apparatus of claim 5, wherein the stereo image is in a side-by-side format or a top-down format.

10. A method of decoding a stereo image, the method comprising:
receiving an encoded bitstream and extracting a stereo image and motion estimation information from the encoded bitstream; and
selectively performing motion compensation through time domain motion estimation or spatial domain motion estimation based on the motion estimation information.

11. The method of claim 10, wherein the spatial domain motion compensation is performed on a left view image of the stereo image using a right view image of the stereo image and the right view image using the left view image if the block to be motion-estimated is located on a left side of the left view image or on a right side of the right view image.

12. The method of claim 10, wherein the time domain motion estimation is performed using a frame prior to a frame including the block to be motion-estimated and the spatial domain motion estimation is performed using another view image in the frame including the block to be motion-estimated.

13. The method of claim 10, wherein the stereo image is in a side-by-side format or a top-down format.

14. An apparatus for decoding a stereo image, the apparatus comprising:
a decoding unit which receives an encoded bitstream and extracts a stereo image and motion estimation information from the encoded bitstream; and
a motion compensation unit which selectively performs motion compensation through time domain motion estimation or spatial domain motion estimation based on the motion estimation information.

15. The apparatus of claim 14, wherein the motion compensation unit performs spatial domain motion compensation on a left view image of the stereo image using a right view image of the stereo image and on the right view image using the left view image if the block to be motion-estimated is located on a left side of the left view image or on a right side of the right view image.

16. The apparatus of claim 14, wherein the time domain motion estimation is performed using a frame prior to a frame including the block to be motion-estimated and the spatial domain motion estimation is performed using another view image in the frame including the block to be motion-estimated.

17. The apparatus of claim 14, wherein the stereo image is in a side-by-side format or a top-down format.

18. A computer-readable recording medium having recorded thereon a program for implementing a method of encoding a stereo, the method comprising:
determining a position of a block to be motion-estimated;
selectively performing time domain motion estimation or spatial domain motion estimation according to the position; and
performing motion compensation according to a result of the performing the time domain motion estimation or the spatial domain motion estimation.

19. A computer-readable recording medium having recorded thereon a program for implementing a method of decoding a stereo image, the method comprising:
receiving an encoded bitstream and extracting a stereo image and motion estimation information from the encoded bitstream; and
selectively performing motion compensation through time domain motion estimation or spatial domain motion estimation based on the motion estimation information.
